(19) United States
(12) Patent Application Publication
(10) Pub. No.: US 2007/0068309 A1
(43) Pub. Date: Mar. 29, 2007

(54) STEERING COLUMN COVER ASSEMBLY

(75) Inventors: Arben Koliqi, Howell, MI (US); George Mikhjian, Troy, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/162,577

(22) Filed: Sep. 15, 2005

(51) Int. Cl. B62D 1/16

(52) U.S. Cl. 74/492

(57) ABSTRACT

A steering column cover assembly for a vehicle. The steering column cover assembly includes an upper housing and a lower housing. The upper housing has an upper flange portion and the lower housing has first and second lower flange portions.

### BACKGROUND OF THE INVENTION

### 1. Field of the Invention

The present invention relates to a cover assembly for a vehicle steering column.

### SUMMARY OF THE INVENTION

In at least one embodiment of the present invention, a steering column cover assembly for a vehicle is provided. The steering column cover assembly includes upper and lower housings. The upper housing has an upper flange portion extending from a first end. The lower housing is configured to be attached to the upper housing and includes a front panel, a bottom panel, and first and second side panels. The bottom panel is disposed adjacent to the front panel. The first and second side panels are disposed adjacent to the front and bottom panels. The first side panel includes a first lower flange portion extending from an end of the first side panel that is disposed opposite the front panel. The second side panel includes a second lower flange portion that extends from an end of the second side panel that is disposed opposite the front panel. The upper flange portion and first and second lower flange portions are configured to flex relative to the upper and lower housings, respectively.

In at least one other embodiment of the present invention, a steering column cover assembly operable to cover a gap between a vehicle instrument panel and a vehicle steering column is provided. The steering column cover assembly includes upper and lower housings. The upper housing has an upper flange portion extending from a first end and a first mating surface. The lower housing has a front panel, a bottom panel, first and second side panels, and a second mating surface. The bottom panel is disposed adjacent to the front panel. The first and second side panels are disposed adjacent to the front and bottom panels. The first side panel has a first lower flange portion that extends from an end of the first side panel disposed opposite the front panel. The second side panel has a second lower flange portion that extends from an end of the second side panel disposed opposite the front panel. The first mating surface is disposed adjacent to the second mating surface and the upper flange portion and first and second lower flange portions overlap to present no visible gaps when the upper housing is assembled to the lower housing.

In at least one other embodiment of the present invention, a steering column cover assembly operable to cover a gap between a vehicle instrument panel and a steering column is provided. The steering column cover assembly includes upper and lower housings. The upper housing includes a front surface, an upper flange portion disposed opposite the front surface, a first mating surface, and a groove disposed adjacent to the upper flange portion. The lower housing has a second mating surface, a front panel, a bottom panel, and first and second side panels. The bottom panel is disposed adjacent to the front panel. The first and second side panels are disposed adjacent to the front and bottom panels. The first side panel has a first lower flange portion that extends from an end of the first side panel disposed opposite the front panel. The second side panel has a second lower flange portion that extends from an end of the second side panel disposed opposite the front panel. The upper flange portion and first and second lower flange portions overlap to present no visible gaps when the first mating surface is disposed adjacent to the second mating surface.

### BRIEF DESCRIPTION OF THE DRAWINGS

FIG. 1 is a side view of a steering column cover assembly installed around a steering column disposed proximate a vehicle instrument panel.

FIG. 2 is an exploded perspective view of the steering column cover assembly shown in FIG. 1.

FIG. 3 is a perspective view of a lower housing of the steering column cover assembly shown in FIG. 2.

FIG. 4 is a perspective of another embodiment of a lower housing of the steering column cover assembly.

FIG. 5 is a side view of another embodiment of a steering column cover assembly.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

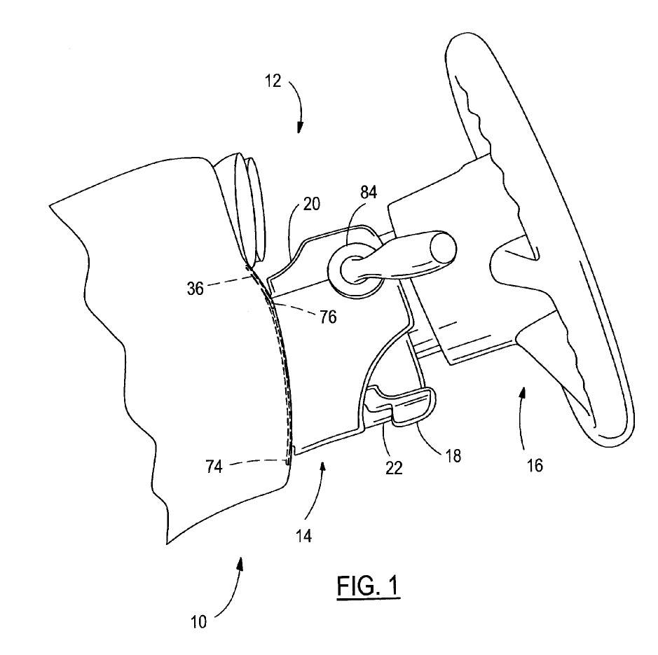

Referring to FIG. 1, an exemplary portion of a vehicle is shown. The vehicle may include an instrument panel 10, a steering column 12, and a steering column cover assembly 14.

The steering column 12 may include a steering wheel 16, steering shaft, a turn signal mechanism, positioning controls, and related wiring. In addition, the steering column 12 and/or the steering wheel 16 may be adjustably positioned relative to the instrument panel 10 or another portion of the vehicle. For example, the steering column 12 or a portion thereof may be tilted, raised, or lowered to position the steering column 12 and/or steering wheel 16 in a desired location. Positioning may be facilitated automatically or by one or more controls, such as an electric switch or a mechanical lever 18 that may be actuated to lock or unlock the steering column 16 to permit manual positioning.

The steering column cover assembly 14 may be disposed around at least a portion of the steering column 12. In the embodiment shown in FIG. 1, the steering column cover assembly 14 is generally disposed between the instrument panel 10 and the steering wheel 16. The steering column cover assembly 14 may be configured to conceal one or more gaps between the steering column 12 and the instrument panel 10 and flex to accommodate positioning of the steering column 12 as will be described in more detail below.

The steering column cover assembly 14 may have any suitable configuration. In the embodiment shown in FIG. 1, the steering column cover assembly 14 includes an upper housing 20 and a lower housing 22. The upper and lower housings 20,22 cooperate to define a cavity that receives at least a portion of the steering column 12. The upper and lower housings may include integral flange portions as will be discussed in greater detail below. Such a design helps eliminate components and complexity, thereby reducing manufacturing and assembly costs.

The upper and lower housings 20,22 may be made of any suitable material or materials. For example, the upper and lower housings 20,22 may be made of a polymeric material, such as thermoplastic olefin (TPO) or polypropylene to help reduce undesirable noises like squeaking that may be caused by contact between the steering column cover assembly 14 and the instrument panel 10 and/or steering column 12. Moreover, the upper and lower housings 20,22 may be fabricated in any suitable manner, such as by a molding process like injection molding.

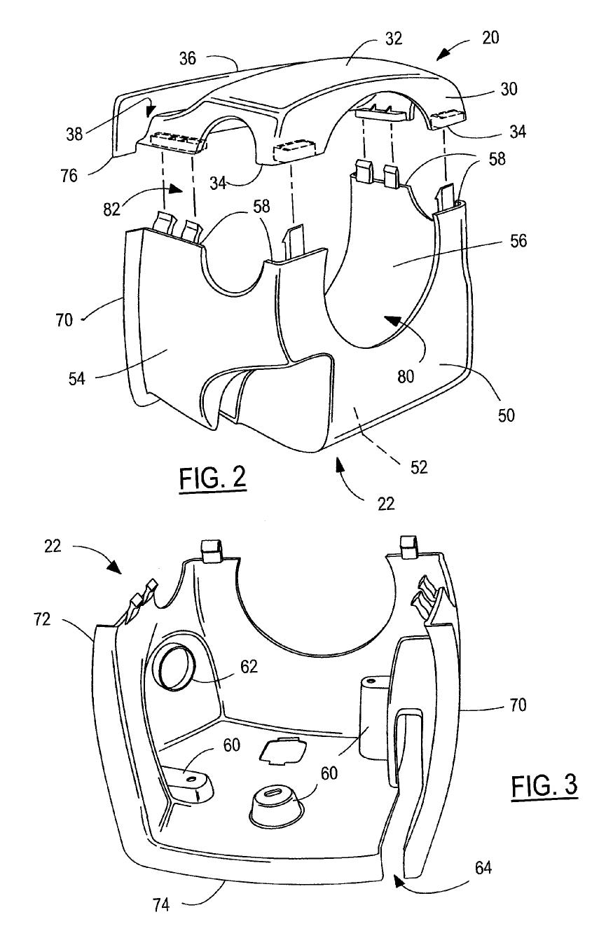

Referring to FIG. 2, one embodiment of the upper housing 20 is shown in more detail. In this embodiment, the upper housing 20 includes a front surface 30, an upper surface 32, one or more lower mating surfaces 34 that are generally disposed opposite the upper surface 32, an upper flange portion 36, and a groove 38.

The upper flange portion 36 may have any suitable configuration. In the embodiment shown, the upper flange portion 36 is disposed opposite the front surface 30 and extends above at least a portion of the upper surface 32. Such a configuration permits the upper flange portion 36 to be at least partially disposed behind or in front of the instrument panel 10 to conceal or cover a gap between the instrument panel 10 and the steering column 12, thereby improving aesthetic appearance. The upper flange portion 36 may be integrally formed with the upper housing 20 and may have a reduced thickness compared to other portions of the upper housing 20 to provide flexibility to accommodate movement of the steering column 12.

The groove 38 may receive a portion of the instrument panel 10 to help conceal a gap between the instrument panel 10 and the steering column 12 and to enhance aesthetic appearance. The groove 38 may be disposed between the front surface 30 and the upper flange portion 36. The groove 38 may have any suitable configuration. In the embodiment shown in FIG. 2, the groove 38 is generally linear and extends across the upper housing 20 adjacent to the upper flange portion 36.

Referring to FIGS. 2 and 3, one embodiment of the lower housing 22 is shown in more detail. In this embodiment, the lower housing 22 includes a front panel 50, a bottom panel 52, a first side panel 54, a second side panel 56, and an upper mating surface 58. In addition, the lower housing 22 may include one or more attachment bosses 60 that facilitate attachment of the lower housing 22 to the steering column 12, a key cylinder opening 62 adapted to receive a key cylinder, and a slot 64 through which the lever 18 extends.

The first and second side panels 54,56 are disposed opposite each other and may extend from the front and bottom panels 50,52. The first and second side panels 54,56 may include first and second lower flange portions 70,72, respectively.

The first and second lower flange portions 70,72 may have any suitable configuration. In the embodiment shown, the first and second lower flange portions 70,72 are disposed opposite the front panel 50 and extend in opposite directions. Such a configuration permits the first and second lower flange portions 70,72 to be disposed in front of or at least partially behind the instrument panel 10 to conceal or cover side gaps between the instrument panel 10 and the steering column 12, thereby improving aesthetic appearance. The first and second lower flange portions 70,72 may be integrally formed with the lower housing 22 and may have a reduced thickness compared to the remainder of the lower housing 22 to provide flexibility to accommodate movement of the steering column 12, yet maintain gap coverage or concealment.

Optionally, the lower housing 22 may also include a bottom flange portion 74 as is best shown in FIG. 3. The bottom flange portion 74 may be integrally formed with the bottom panel 52 and may extend away from the upper mating surface 58. The bottom flange portion 74 may be disposed in front of or at least partially behind the instrument panel 10 to conceal or cover a gap between the instrument panel 10 and the steering column 12. The bottom flange portion 74 may extend generally perpendicular to the bottom panel 52. In addition, the bottom flange portion 74 may have a reduced thickness compared to the remainder of the lower housing 22 to provide flexibility to accommodate movement of the steering column 12.

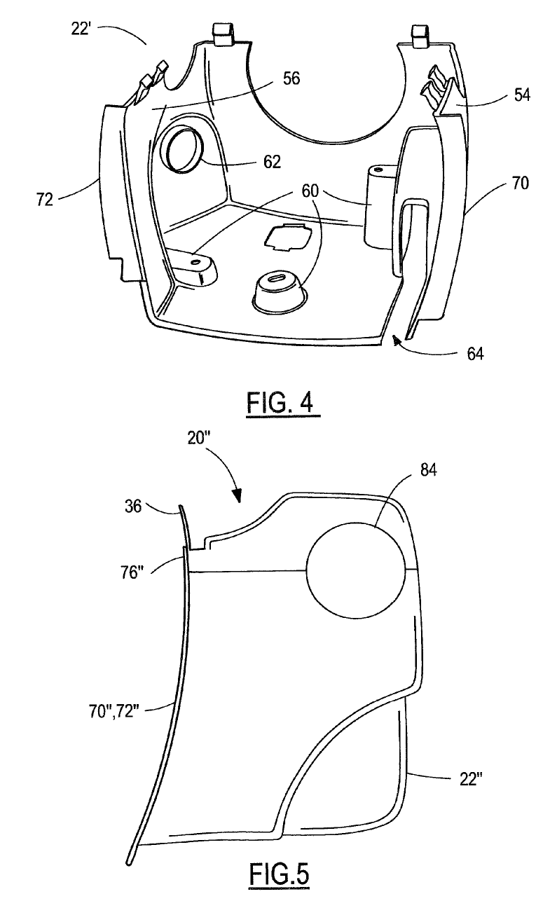

The present invention also contemplates embodiments in which one or more flange portions are omitted. For instance, a lower housing 22′ may be provided an embodiment of the lower housing 22′ is shown that does not include a bottom flange portion as shown in FIG. 4.

Optionally, the upper flange portion 36 may be configured to overlap the first and/or second lower flange portions 70,72 or vice versa to cover or conceal gaps between the corresponding flange portions and to improve aesthetic appearance. For example, the upper flange portion 36 may include one or more extension portions 76 that extend past the lower mating surface 34 and overlap the first and second lower flange portions 70,72. In an alternate embodiment, such as is shown in FIG. 5, the lower housing 22″ includes first and second lower flange portions 70″,72″ having extension portions 76″ that overlap the upper flange portion. As such, the present invention provides improved gap concealment not only around the steering column, but also between the upper and lower housings.

The steering column cover assembly 14 may be assembled by positioning the upper and lower housings 20,22 around the steering column 12 such that the upper and lower mating surfaces 34,58 are disposed adjacent to each other. When assembled, the upper and lower housings 20,22 may also cooperate to define one or more openings. As best visualized in FIGS. 1 and 2, these openings may include front and rear openings 80,82 through which the steering column 12 extends and one or more side openings 84 through which a turn signal mechanism or other controls may extend.

The upper and lower housings 20,22 may be attached to each other in any suitable manner, including, but not limited to an adhesive, fasteners, snap tabs, vibration welding, sonic welding, heat staking, or combinations thereof. In the embodiment shown in FIG. 2, snap tabs are provided that extend from the lower housing 22 to engage a corresponding receiving feature disposed on the upper housing 20. Of course, the present invention also contemplates embodiments in which snap tabs may be provided on the upper housing 20 and receiving features may be provided on the lower housing 22.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A steering column cover assembly for a vehicle, the steering column cover assembly comprising:
an upper housing having a first end and an upper flange portion extending from the first end; and
a lower housing configured to be attached to the upper housing, the lower housing including:
a front panel,
a bottom panel disposed adjacent to the front panel,
a first side panel disposed adjacent to the front and bottom panels, the first side panel having a first lower flange portion extending from an end of the first side panel disposed opposite the front panel, and
a second side panel disposed adjacent to the front and bottom panels, the second side panel having a second lower flange portion extending from an end of the second side panel disposed opposite the front panel;
wherein the upper flange portion is configured to flex relative to the upper housing and the first and second lower flange portions are configured to flex relative to the lower housing.

2. The steering column cover assembly of claim 1 wherein the upper flange portion overlaps the first and second lower flange portions to provide no visible gaps therebetween.

3. The steering column cover assembly of claim 2 wherein the upper housing includes a first mating surface and the upper flange portion includes at least one extension portion that extends past the first mating surface, the at least one extension portion being disposed adjacent to and overlapping at least one of the first and second lower flange portions.

4. The steering column cover assembly of claim 1 wherein the lower housing includes a second mating surface, wherein the first and second lower flange portions extend past the second mating surface and contact and overlap the upper flange portion.

5. The steering column cover assembly of claim 1 wherein the bottom panel further comprises a third lower flange portion that extends from an end of the bottom panel disposed opposite the front panel.

6. The steering column cover assembly of claim 1 wherein the upper and lower housings are made of a thermoplastic elastomer.

7. The steering column cover assembly of claim 1 wherein the upper and lower housings cooperate to define a cavity, a front opening, and a rear opening.

8. A steering column cover assembly operable to cover a gap between a vehicle instrument panel and a steering column, the steering column cover assembly comprising:
an upper housing including:
a first mating surface, and
an upper flange portion extending from a first end; and
a lower housing including:
a front panel,
a bottom panel disposed adjacent to the front panel,
a first side panel disposed adjacent to the front and bottom panels, the first side panel having a first lower flange portion extending from an end of the first side panel disposed opposite the front panel,
a second side panel disposed adjacent to the front and bottom panels, the second side panel having a second lower flange portion extending from an end of the second side panel disposed opposite the front panel, and
a second mating surface;
wherein the upper flange portion and the first and second lower flange portions overlap to present no visible gaps when the first mating surface is disposed adjacent to the second mating surface.

9. The steering column cover assembly of claim 8 wherein the upper and lower housings are attached to each other with at least one snap tab.

10. The steering column cover assembly of claim 8 wherein the lower housing includes at least one attachment boss for attaching the lower housing to the steering column.

11. The steering column cover assembly of claim 8 wherein the upper flange portion and the first and second lower flange portions are thinner than adjacent portions of the upper and lower housings, respectively, to permit the upper flange portion and first and second lower flange portions to flex.

12. The steering column cover assembly of claim 8 wherein the upper and lower housings cooperate to define a cavity and front and rear openings through which the steering column extends when the steering column cover assembly is disposed around the steering column.

13. The steering column cover assembly of claim 8 wherein the upper and lower housings cooperate to define at least one side opening.

14. The steering column cover assembly of claim 8 wherein the upper housing further comprises a generally linear groove disposed adjacent to the upper flange portion that extends across the upper housing generally parallel to the upper flange portion.

15. The steering column cover assembly of claim 8 wherein the bottom panel further comprises a third lower flange portion that extends from the bottom panel in a direction disposed generally away from the second mating surface.

16. A steering column cover assembly operable to cover a gap between a vehicle instrument panel and a steering column, the steering column cover assembly comprising:
an upper housing including:
a front surface,
an upper flange portion disposed opposite the front surface,
a groove disposed adjacent to the upper flange portion, and
a first mating surface; and
a lower housing including:
a front panel,
a bottom panel disposed adjacent to the front panel,
a first side panel disposed adjacent to the front and bottom panels, the first side panel having a first lower flange portion extending from an end of the first side panel disposed opposite the front panel,
a second side panel disposed adjacent to the front and bottom panels, the second side panel having a second lower flange portion extending from an end of the second side panel disposed opposite the front panel, and
a second mating surface;
wherein the upper flange portion is provided in an overlapping arrangement with the first and second lower flange portions when the first mating surface is disposed adjacent to the second mating surface.

17. The steering column cover assembly of claim 16 wherein the bottom panel further comprises a slot extending from a rear surface toward the front panel.

18. The steering column cover assembly of claim 16 wherein the groove is generally linear and extends across the upper housing.

19. The steering column cover assembly of claim 16 wherein the upper flange portion further comprises first and second extension portions that extend past the first mating surface, the first and second extension portions being disposed adjacent to and overlapping the first and second lower flange portions, respectively.

20. The steering column cover assembly of claim 16 wherein the first and second lower flange portions extend past the second mating surface and contact and overlap the upper flange portion.
